(19) United States
(12) Patent Application Publication
(10) Pub. No.: US 2017/0052936 A1
(43) Pub. Date: Feb. 23, 2017

(54) COMPUTER SOFTWARE PROGRAM FOR THE AUTOMATED IDENTIFICATION AND REMOVAL OF ABBREVIATIONS AND ACRONYMS IN ELECTRONIC DOCUMENTS

(71) Applicants: Norman A. Paradis, Putney, VT (US); Aidan B. Paradis, Putney, VT (US)

(72) Inventors: Norman A. Paradis, Putney, VT (US); Aidan B. Paradis, Putney, VT (US)

(21) Appl. No.: 14/832,050

(22) Filed: Aug. 21, 2015

(51) Int. Cl. G06F 17/24; G06K 9/00

(52) U.S. Cl. CPC G06F 17/24; G06K 9/00469

(57) ABSTRACT

A computer software program that enhances the readability of electronic documents containing abbreviation or acronym. The program automatically identifies abbreviations and acronyms based on their first definitional use. It then identifies each subsequent use of the abbreviation or acronym and substitutes the appropriate full word or phrase for the abbreviation or acronym. Optionally or alternatively, the program may also identify abbreviations or acronyms that are in general use but have not been specifically defined within the document and offers substitution of the appropriate full word or phrase.

### FIELD OF THE INVENTION

The invention disclosed here relates in general to the field of computer software applications that act upon electronic documents. In particular, to computer software and applications for automated document editing and transformation.

### BACKGROUND OF THE INVENTION

It is common in scientific, technical, and medical writing to use abbreviations and acronyms.

Merriam Webster defines an abbreviation as “a shortened form of a word or name that is used in place of the full word or name.

Merriam Webster defines an acronym as “a word formed from the first letters of each one of the words in a phrase”

Generally, abbreviations are utilized when it is anticipated that a word will be used repetitively within the document, and acronyms are utilized when it is anticipated that a phrase or sequence of words will be used repetitively within the document.

In scientific, technical, and medical writing, an abbreviation is commonly the substitution of one or more capital letters for a single word. The abbreviation is generally defined at the first use of the full word by following that word with one or more capital letters in brackets or parenthesis. In an example, an abbreviation for the word “example” might be defined as . . . “example (EX) . . . ”

In scientific, technical, and medical writing, an acronym is commonly the substitution of multiple capital letters for a phrase or sequence of words. The acronym is generally defined at the first use of the phrase by following that phrase capital letters in brackets or parenthesis. In example, an acronym for the phrase “in example” would be defined as . . . “in example (IE) . . . ”

The use of abbreviations and acronyms most likely developed during the many years in which documents were prepared and published in hard copy form on paper. Abbreviations and acronyms were intended to limit use of paper and published pages. For instance, a scientific journal might be published monthly and be limited with respect to the total number of pages in each issue. Use of abbreviations and acronyms within the articles would shorten the length of each article and allow publication of more articles on fewer pages.

With the advent of computers, electronic documents, and the Internet, limiting the use of pages is no longer as important. However, abbreviations and acronyms continue to be used.

The use, and occasionally the overuse, of abbreviations and acronyms may significantly impair the readability of documents. It is not uncommon in scientific, technical, or medical publications for the authors to define and utilize more than a dozen abbreviations and acronyms within a single article. In some cases, the abbreviations and acronyms utilized are in wide use and are known to the reader. Under such circumstance, readability may not be impaired. However, scientific and technical authors will commonly define multiple abbreviations and acronyms unique to their article. This forces the reader to learn and remember these definitions at the same time that they are attempting to understand the concepts put forth in the article itself. The use and overuse of abbreviations and acronyms can render a technical or scientific article much more difficult to read.

Additionally, on occasion, the writers of scientific and technical articles will use an abbreviation or acronym without the initial definition because they believe that the abbreviation or acronym in wide use. If the reader is unfamiliar with these abbreviations or acronyms the article will be difficult for the reader to understand.

### DESCRIPTION OF THE RELATED ART

There is no prior art teaching the use of computer software to render documents containing abbreviations and acronyms more readable by identifying each abbreviation or acronym within a document and substituting the full word or phrase.

The following comprehensive searches of the World Wide Web yielded no resulting teaching the invention:

A search for a combination of “software” “management” and “abbreviations”.

A search for a combination of “abbreviation” and “substitution”.

A search for a combination of “abbreviation” “find” and “replace.”

Searches for all combination of abbreviation, acronym, find, replace, automatic, substitute, software, and application yielded no results teaching the invention. All related software require the user to find each abbreviation or acronym and manually define the “find and replace” operation.

### SUMMARY OF THE INVENTION

A computer software program that enhances the readability of electronic documents containing abbreviation or acronym. The program automatically identifies abbreviations and acronyms based on their first definitional use. It then identifies each subsequent use of the abbreviation or acronym and substitutes the appropriate full word or phrase for the abbreviation or acronym. Optionally, the program may also identify abbreviations or acronyms that are in general use but have not been specifically defined within the document and offers substitution of the appropriate full word or phrase.

### DETAILED DESCRIPTION OF A PREFERRED EMBODIMENT

### What Has Been Invented?

A computer software program that enhances the readability of electronic documents containing abbreviation or acronym. The program automatically identifies abbreviations and acronyms based on their first definitional use. It then identifies each subsequent use of the abbreviation or acronym and substitutes the appropriate full word or phrase for the abbreviation or acronym. Optionally or alternatively, the program may also identify abbreviations or acronyms that are in general use but have not been specifically defined within the document and offers substitution of the appropriate full word or phrase.

The program automatically identifies abbreviations and acronyms at their first definitional use. The abbreviation or acronym is identified at its first use by the presence of one or more capital letters in brackets or parenthesis following a word or sequence of words in which the first letter of the first word is the same letter as the first letter of the capitalized letters in brackets or parenthesis. The program then identifies each subsequent use of the abbreviation or acronym within the document and substitutes the full word or phrase for the abbreviation or acronym.

Optionally, the program may also identify generally utilized abbreviations or acronyms that may not be specifically defined within the document and offers substitution of the appropriate full word or phrase.

### Mode That May Be Constructed By Someone Skilled in the Art

Although not necessarily the optimal implementation of the invention, an exemplary or preferred implementation that would be readily constructed by someone with ordinary skill in the art, once informed of the invention, would include computer code that: Would identify and remove abbreviations and acronyms in electronic documents, by scanning electronic documents for the first and definitional instance of an abbreviations and acronyms and then substitutes the full word or expression throughout the document.

Generally, the first definitional use of an abbreviation or acronym is easily identified. In the case of an abbreviation, the word will be followed by brackets [] or parenthesis ( ) containing one or more capital letters. The first capital letter will generally be the same as the first letter of the word: “example (EX) . . . ”

In the case of an acronym, the phrase will be followed by brackets [] or parenthesis ( ) containing multiple capital letters. Generally, each capital letter will be the same as the first letter in each word of the phrase: “in example (IE) . . . ”

Once the computer program has identified each abbreviation or acronym it will substitute the full word or phrase in each subsequent use throughout the document. This “find and replace” function can be automatic throughout the document, or allow the user to confirm the correctness and approve the substitution. Substitution can be automatic for the whole document or with approval from the user in each instance.

The computer program may also contain the capability to restore the electronic document to its original state.

An additional exemplary or preferred implementation that would be readily constructed by someone with ordinary skill in the art, would be computer software code that scans electronic documents for the first and definitional instance of abbreviations or acronyms and then creates a list of the abbreviations and acronyms and their definitions that would be readily available at each instance of an abbreviation or acronym. Readily available could be as a “pop-up” screen or overlay window.

An additional exemplary or preferred implementation that would be readily constructed by someone with ordinary skill in the art, would be computer software code that scans electronic documents for instances of pre-defined and generally accepted abbreviations or acronyms and then substitutes the full word or expression for the abbreviation or acronym throughout the document. Alternatively, the software could make the full word or expression readily available at each instance of an abbreviation or acronym. Readily available could be as a “pop-up” screen or overlay window.

Once informed of the invention, someone skilled in the art would appreciate that:
1. The application could be either free-standing or a module within other software.
2. The application could be ported to any computer language.
3. The application could be written to act on any type of electronic document.
4. A dictionary of generally used abbreviations or acronyms may be included within the application

The specific computer code need not be specified as any practitioner with ordinary skill in the art would know, once taught, that there are multiple methods in the design and writing of computer code to achieve the documents changes taught within the current inventions. More specifically, the invention as taught is computer, computer language, and computer code independent

### USEFULNESS OF THE DISCLOSED INVENTION

Once it is understood that the invention disclosed herein automates identification and removal of abbreviations and acronyms in electronic documents rendering them more comprehensible and readable, the usefulness will be obvious to anyone with ordinary skill in the art.

### Non-Obviousness

The non-obviousness of the invention herein disclose is demonstrated by the complete absence of its appreciation or discussion in the technical, scientific and library literature. Additionally, a numerous commercial enterprises produce software and applications to enhance utility of computer based documents, none of these companies have disclosed or developed methods or systems such as disclosed herein.

The complete absence of discussion or reference to the invention as taught herein in the technical, biomedical and intellectual property literature meets the standard for non-obviousness set by the Court of Appeals for the Federal Circuit in re Zurko, 258 F.3d 1379, 1385 (Fed. Cir. 2001) and K/S HIMPP v. Hear-Wear Technologies, LLC, 751 F.3d 1362 (Fed. Cir. 2014). “The Federal Circuit's obviousness decisions consistently demand written, documentary evidence—published articles or patent applications that specifically include all the details of the claim.”

### Other Publications Incorporated in the Current Application by Reference

None

### Modifications

It will be understood that many changes in the details, materials, steps and arrangements of elements, which have been herein described and illustrated in order to explain the nature of the invention, may be made by those skilled in the art without departing from the scope of the present invention.

Since many modifications, variations and changes in detail can be made to the described preferred embodiment of the invention, it is intended that all matters in the foregoing description be interpreted as illustrative and not in a limiting sense. Thus, the scope of the invention should be determined by the appended claims and their legal equivalents.

Now that the invention has been described,

What is claimed is:

1. A method for enhancing the readability of electronic documents containing abbreviations and or acronyms the method comprising:
computer software code that scans electronic documents for the first and definitional instances of abbreviations or acronyms and then substitutes the full word or expression for the abbreviation or acronym throughout the document.

2. A method according to claim 1, wherein the computer program restores the electronic document to its original state.

3. A method for creating a list of abbreviations and acronyms in electronic documents, comprising:
computer software code that scans electronic documents for the first and definitional instance of abbreviations or acronyms and then creates a list of the abbreviations and acronyms and their definitions.

4. A method according to claim 3, wherein the computer program renders the list readily available at each use of an abbreviation or acronym.

5. A method for the identification and removal of generally established and defined abbreviations and acronyms in electronic documents, comprising:
computer software code that scans electronic documents for instances of pre-defined and generally accepted abbreviations or acronyms and then substitutes the full word or expression for the abbreviation or acronym throughout the document.

6. A method according to claim 1, wherein the computer program limits the abbreviations or acronyms to which it performs substitution of the full word or expression for the abbreviation or acronym to abbreviations or acronyms appearing more than a minimum number of times within the document.

7. A method according to claims 6, wherein the minimum number of times that the abbreviation or acronym appears within the document is three.

8. A method according to claim 1, wherein the abbreviation or acronym is identified at its first use by the presence of one or more capital letters in brackets or parenthesis following a word or sequence of words in which the first letter of the first word is the same letter as the first letter of the capitalized letters in brackets or parenthesis.

9. A method according to claim 8, wherein the algorithm or definition utilized for identification of an abbreviation or acronym is user customizable.

10. A method according to claim 5, wherein the reader identifies the subject area of the article, and this determines the list of pre-defined and generally accepted abbreviations or acronyms that is utilized.
